(19) United States
(12) Patent Application Publication
(10) Pub. No.: US 2017/0214290 A1
(43) Pub. Date: Jul. 27, 2017

(54) ACTUATOR

(71) Applicant: OHFA Tech, Inc., Gumi-si (KR)

(72) Inventors: Kyounghwang LEE, Yangpyeong-gun (KR); Jae Ryun CHO, Anyang-si (KR); Minsung SON, Seoul (KR)

(21) Appl. No.: 15/379,482

(22) Filed: Dec. 15, 2016

(30) Foreign Application Priority Data
Jan. 22, 2016 (KR) 10-2016-0008378

(51) Int. Cl. H02K 7/06; F16K 31/04

(52) U.S. Cl. CPC H02K 7/06; F16K 31/047

(57) ABSTRACT

An actuator is provided, which includes: a rotary driver having a rotary shaft; a driving member coupled to the rotary shaft of the rotary driver and having a driving surface; a driven member, supported by the driving surface of the driving member, configured to linearly move along the rotary shaft by a rotation of the driving member without rotating around the rotary shaft.

### CROSS REFERENCE TO RELATED APPLICATIONS

This application claims priority of Korean Patent Application No. 10-2016-0008378, filed on Jan. 22, 2016, the entire contents of which are incorporated herein by reference.

### TECHNICAL FIELD

The present disclosure generally relates to actuators, and more particularly, to an actuator to linearly move an object.

### BACKGROUND ART

An actuator is a mechanical device used to move or control a system.

The term “actuator” is widely used to refer to a remote driving device that uses electricity, hydraulic power, compressed air, etc., and functions with an energy source in the form of electrical current, actuating hydraulic power, voltage, etc. A typical example of an actuator is a “solenoid” which converts a movement caused by such an energy source, for example, into a linear movement.

A solenoid is configured such that a coil is wound around a cylinder to generate a magnetic field therein to linearly move an active rod installed in the cylinder in one direction.

When an active rod is used, however, a constant electric power should be applied to the coil of the solenoid if the active rod is to be maintained at its displaced state.

### Technical Problem

Accordingly, there is a need for an actuator which can maintain the linear movement after its driven member has moved linearly without applying an electric power to thereby minimize the energy consumption used to drive the actuator.

### Technical Solution

In an exemplary embodiment, there is provided an actuator, which comprises: a rotary driver 10 having a rotary shaft 11; a driving member 30 coupled to the rotary shaft 11 of the rotary driver 10 and having a driving surface 20; a driven member 40, supported by the driving surface 20 of the driving member 30, configured to linearly move along the rotary shaft 11 by a rotation of the driving member 30 without rotating around the rotary shaft 11.

The driving surface 20 may comprise a first supporting surface 21, a first sloped surface 22, a second support surface 23, and a second sloped surface 24 continuously in sequence along a circumferential direction around the rotary shaft 11. The first supporting surface 21 and the second supporting surface 23 may have a gap in height in a longitudinal direction of the rotary shaft 11.

The driven member 40 may comprise a driven surface 41 which is in surface contact with the driving surface 20 so as to linearly move through a rotation of the driving member 30.

The driven member 40 may comprise a driven surface 41 which matches in shape to the driving surface 20.

The actuator may further comprise: a first rotation restrictor 38 which is connected to at least one of the rotary shaft 11 and the driving member 30, and at least one second rotation restrictor 58, 59 which allows the first rotation restrictor 38 to rotate within a predetermined angle of degrees.

The driving surface 20 may comprise at least one second supporting surface 23 which supports the driven member 40 at a location corresponding to a farthest point where the driven member 40 is displaced farthest from the rotary shaft 11, and at least one sloped surface 22, 24, connected to the at least one second supporting surface 23, which supports the driven member 40 at a location corresponding to a nearest point where the driven member 40 is displaced nearest from the rotary shaft 11.

The actuator may further comprise a guide 50 which guides the driven member 40 to move linearly while preventing the driven member 40 from rotating around the rotary shaft 11.

One of the guide 50 and the driven member 40 may be equipped with at least one guide groove formed along the linear movement of the driven member 40, and the other of the guide 50 and the driven member 40 may be equipped with a protrusion which corresponds to the guide groove so that the protrusion moves linearly along the guide groove.

The actuator may further comprise an adhesion mechanism which keeps the driven surface 41 of the driven member 40 adhered to the driving surface 20.

The adhesion mechanism may keep the driven surface 41 of the driven member 40 adhered to the driving surface 20 through a magnetic force or an elastic force.

The adhesion mechanism may comprise a magnet 61 installed in at least one of the driven member 40 and the driving member 30.

The adhesion mechanism may comprise an elastic member which applies an elastic force to the driven member 40 against the driving member 30.

### Advantageous Effects

The actuator according to the present disclosure comprises: a rotary driver having a rotary shaft; a driving member coupled to the rotary shaft of the rotary driver and having a driving surface; a driven member, supported by the driving surface of the driving member, configured to linearly move along the rotary shaft by a rotation of the driving member without rotating around the rotary shaft, which simplifies the overall structure of the actuator and facilitates easy installation of the actuator to thereby significantly reduce the manufacturing cost.

The actuator according to the present disclosure comprises: a rotation restriction mechanism which includes a guide groove and a protrusion inserted into the guide groove, which simplifies the overall structure of the actuator to thereby significantly reduce the manufacturing cost.

The actuator according to the present disclosure can maintain the linear movement after its driven member has moved linearly without applying an electric power to thereby minimize the energy consumption to drive the actuator.

The actuator according to the present disclosure uses at least one of a magnet or an elastic member as an adhesion means to adhere the driven member to the driving member, which simplifies the overall structure of the actuator and facilitates easy installation of the actuator to thereby significantly reduce the manufacturing cost.

### BRIEF DESCRIPTION OF DRAWINGS

FIG. 1 is a perspective view showing a part of an actuator according to an embodiment of the present disclosure;

FIGS. 2A and 2B are longitudinal sectional views of the actuator shown in FIG. 1, respectively. FIG. 2A illustrates a driven member prior to a linear movement, and FIG. 2B illustrates the driven member after the linear movement;

FIG. 2C is a plan view showing a driving surface of the driving member presented in the actuator shown in FIG. 1;

FIGS. 3A and 3B are longitudinal sectional views of the actuator of another embodiment of the present disclosure, respectively. FIG. 3A illustrates a driven member prior to a linear movement, and FIG. 3B illustrates the driven member after the linear movement;

FIGS. 4A and 4B are partial cross-sectional views of a portion of the driven member, a first rotation restrictor and a second rotation restrictor illustrated in FIG. 3A, respectively;

FIG. 5A is a cross-sectional view of IV-IV direction from FIG. 3A;

FIG. 5B is a modified embodiment of FIG. 5A, which illustrates a cross-sectional view of another example of a guide;

FIG. 6 is a partial perspective view of an actuator according to another embodiment of the present disclosure which is equipped with a drive member of a modified shape and structure;

FIG. 7 is a partial exploded perspective view of the actuator shown in FIG. 6; and

FIGS. 8A and 8B are a longitudinal sectional view illustrating the operation of the actuator of FIG. 6.

### MODE FOR INVENTION

Hereinafter, an actuator in accordance with the present disclosure will be described in detail with reference to the accompanying drawings.

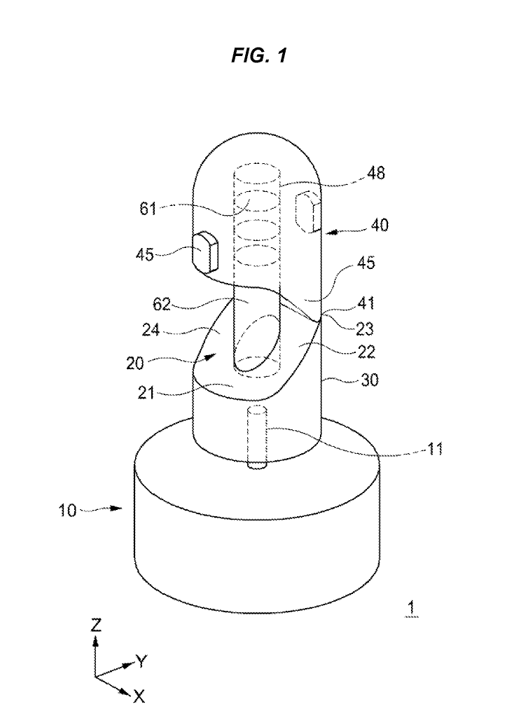

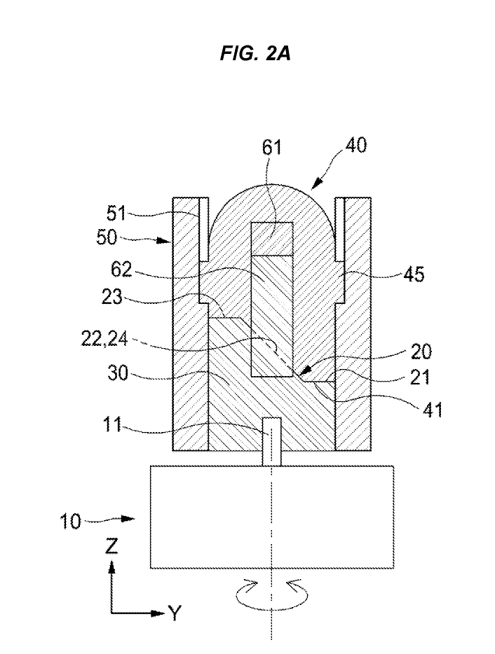

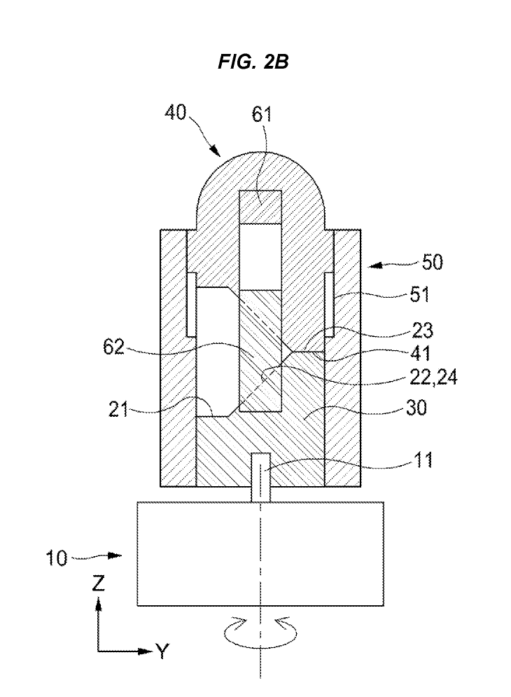

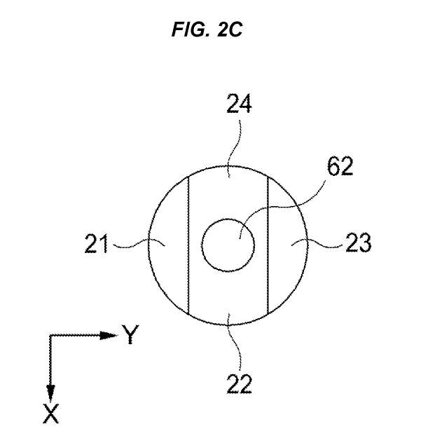

As illustrated in FIGS. 1 to 2C, the actuator in accordance with the present disclosure includes a rotary actuator 10 having a rotary shaft 11, a driving member 30 coupled to the rotary shaft 11 of the rotary driving portion 10 and has a driving surface 20, a driven member 40 which is supported by the driving surface of the driving member 30 and moved linearly along the longitudinal direction of the rotary shaft 11 by the rotation of the driving member 30 without being rotated around the rotary shaft 11.

The actuator according to the present disclosure can be used as a device to linearly move an object coupled to the driven member 40, such as a locking member of a door lock, a valve member of a valve, etc., by linearly moving the driven member 40.

The rotary actuator 10 can have any configuration that generates rotary driving force around a rotary shaft 11.

As an example, a rotary motor such as an electrical motor, a hydraulic motor, etc., can be used as the rotary driver 10. A step motor which rotates with a predetermined degree of angle may be preferably used as a rotary motor.

As another example, the rotary driver 10 can be a combination of a permanent magnet coupled to a lower surface of the driving member 30 and a solenoid which rotates the i.e., the driving member 30 around the rotary shaft 11.

On the other hand, the rotary driver 10 may have various configurations. For example, the rotary driver 10 may be configured such that the driving member 30 rotates with an interval of 180 degrees. In another configuration, the driving member 30 may rotate up to predetermined degrees and rotate back to the original position.

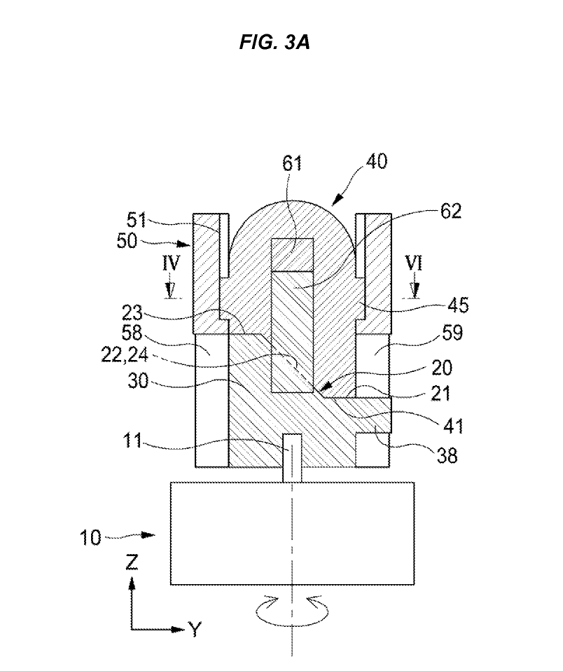

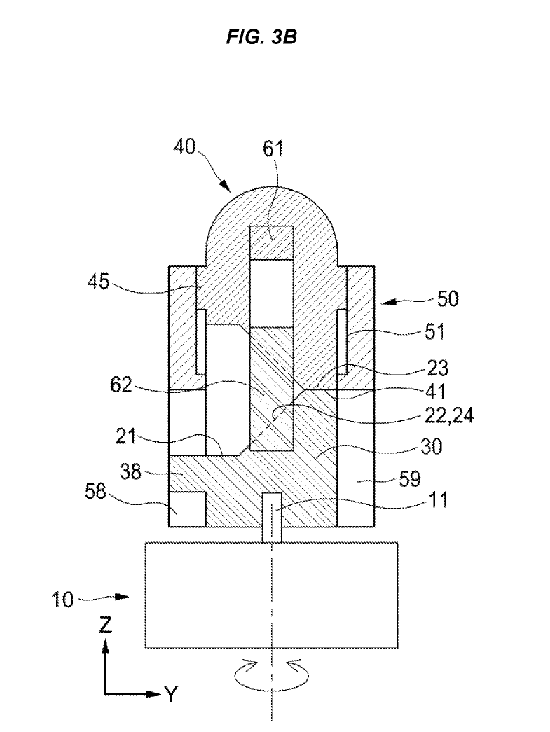

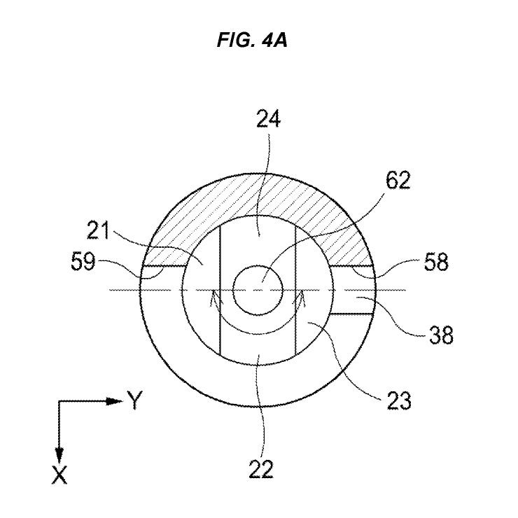

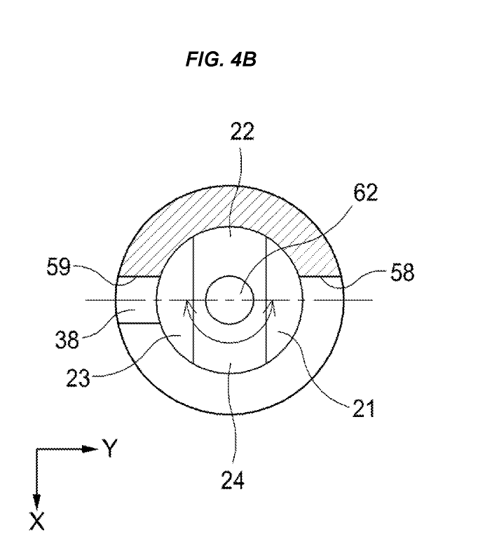

FIGS. 3A to 4B illustrate an example of a driving member 30 that rotates back and forth within a predetermined range of degrees, e.g., 180 degrees. As shown in FIGS. 3A to 4B, the actuator is equipped with a first rotation restrictor 38 which is coupled to one of the rotary shaft 11 and the driving member 30, and at least one second rotation restrictor 58, 59 which allows the first rotation restrictor 38 to rotate within a predetermined angle of degrees, e.g., 180 degrees.

The first rotation restrictor 38 and the at least one second rotation restrictor 58, 59 may have any configurations which allow the driving member 30 to rotate back and forth within a range of 180 degrees.

For example, as illustrated in FIGS. 3A to 4B, the first rotation restrictor 38 may be a protrusion formed by projecting in a radial direction from the driving member 30 and the at least one second rotation restrictor 58, 59 may be a stopper that restricts rotation of the protrusion formed on the driving member 30.

The stopper may have various configurations. An exemplary configuration of the stopper is an incision provided at a guide 50, which will be explained below.

The driving member 30 may also have various configurations. In one exemplary configuration, the driving member 30 may be coupled to the rotary shaft 11 of the rotary driver 10 and may have a driving surface 20 to support a driven surface 41 of a driven member 40 so as to linearly move the driven member 40 when the rotary driver 10 is rotated.

Specifically, the driving surface 20 may include a first supporting surface 21, a first sloped surface 22, a second supporting surface 23, and a second sloped surface 24 in sequence, when viewed from above, around the rotary shaft 11 in a circumferential direction.

The first supporting surface 21 and the second supporting surface 23 may be formed such that they have a gap in heights in a longitudinal direction along the rotary shaft 11.

The driving surface 20 may have a continuous surface including the first supporting surface 21, the first sloped surface 22, the second supporting surface 23 and the second sloped surface 24 in sequence such that, as the driving member 30 is rotated in accordance with the rotation of the rotary shaft 11, each one of the first supporting surface 21, the first sloped surface 22, the second supporting surface 23 and the second sloped surface 24 supports the driven surface 41 of the driven member 40 sequentially.

As shown in FIG. 2C, the first supporting surface 21, the first sloped surface 22, the second supporting surface 23 and the second sloped surface 24 may be disposed sequentially to have a predetermined angle of degrees in between, e.g., 180 degrees, around the rotary shaft 11.

The first supporting surface 21 and the second supporting surface 23 may be formed such that they have a gap in heights in the longitudinal direction along the rotary shaft 11. In other words, the first supporting surface 21 is formed closer to the rotary driver 10 than the second supporting surface 23. Then, the first sloped surface 22 and the second sloped surface 24 may be formed to connect the first supporting surface 21 and the second supporting surface 23 to constitute a single continuous driving surface 20.

Each of the first supporting surface 21 and the second supporting surface 23 may have various shapes such as a concave surface, a convex surface, a planar surface, etc. While not limited thereto, each of the first supporting surface 21 and the second supporting surface 23 may be preferably a planar surface perpendicular to the rotary shaft 11 so as to maintain the supporting state of the driven surface 41 of the driven member 40 even if the rotary driver 10 is in an off state.

Each of the first sloped surface 22 and the second sloped surface 24 connects the first supporting surface 21 and the second supporting surface 23. While not limited thereto, each of the first sloped surface 22 and the second sloped surface 24 may preferably be a curved surface having a varying curvature at the edge between the first supporting surface 21 or the second supporting surface 23 so as to form a continuous surface with the first supporting surface 21 and the second supporting surface 23.

On the other hand, in case the rotary driver 10 rotates back and forth in a restricted angle, the rotation may be enough in either one direction between the first supporting surface 21 and the second supporting surface 23. In such case, forming one of the first sloped surface 22 and the second sloped surface 24 may be enough.

Also, depending on the supporting configuration, one of the first supporting surface 21 and the second supporting surface 23 to support the driven member 40 may be omitted. For instance, the first supporting surface 21 may be omitted from the overall configuration.

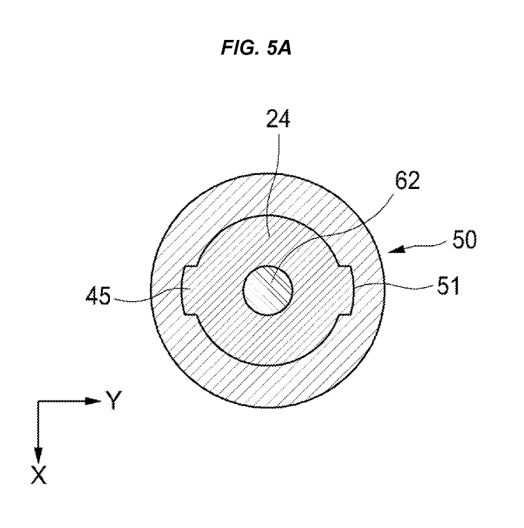

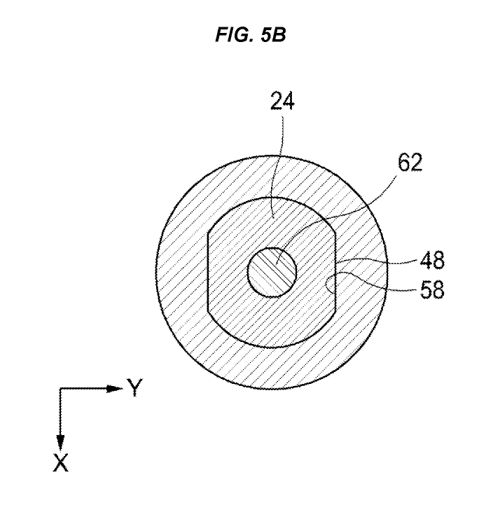

Various shapes and structures for the driving member 40, other than the ones illustrated in FIGS. 1 to 5B, may be also possible so long as the driving member 40 may support and linearly move the driven member 40 with a driving surface 20 formed thereon.

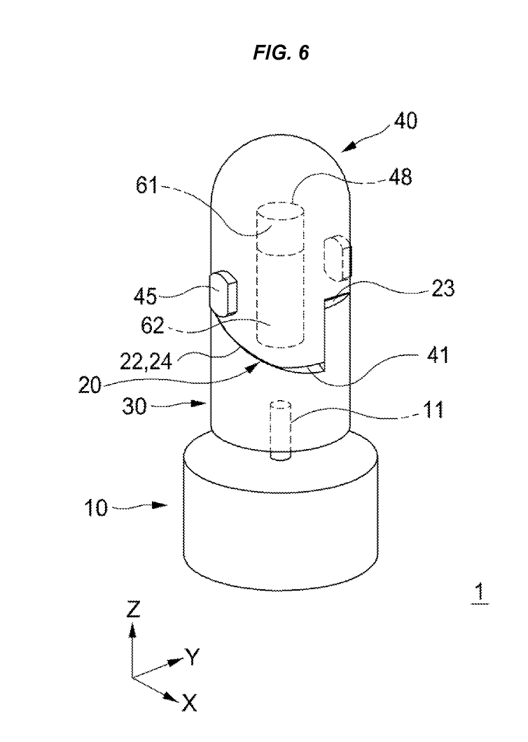

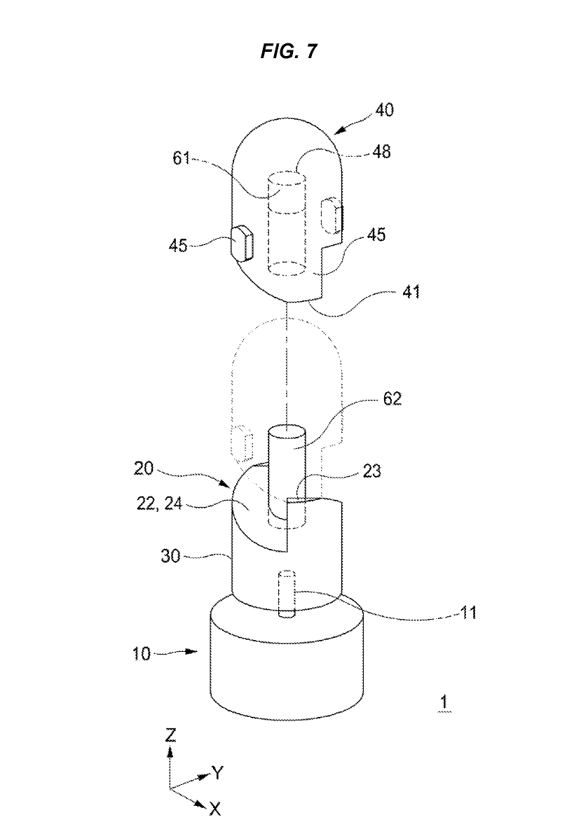

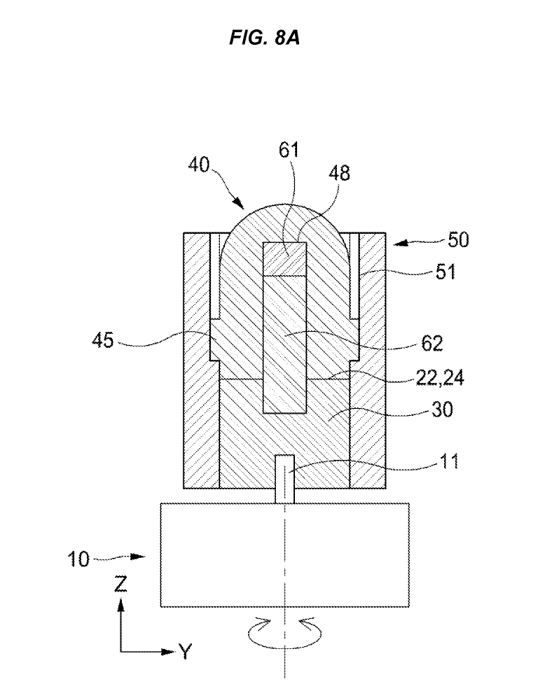

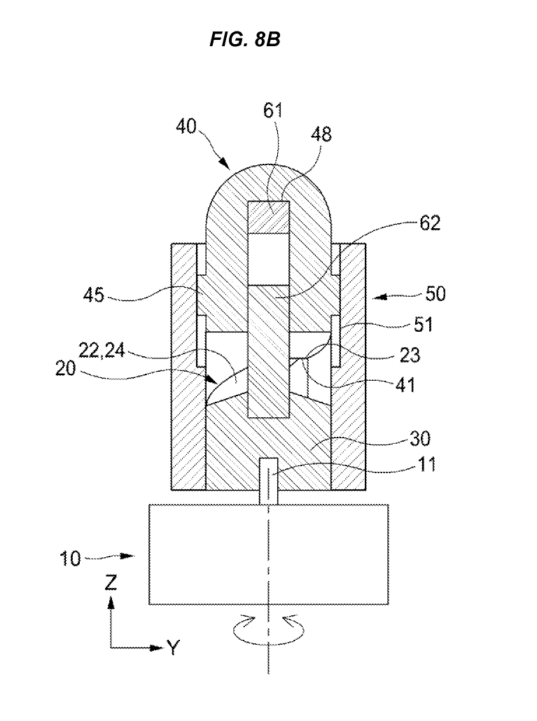

FIGS. 6 to 8B illustrate a modified embodiment of the embodiment illustrated in FIGS. 1 to 5B. The driving surface (20) of the driving member (30) may comprise at least one second supporting surface (23) which supports the driven member (40) at a location corresponding to a farthest point where the driven member (40) is displaced farthest from the rotary shaft (11), and at least one sloped surface (22, 24), connected to the at least one second supporting surface (23), which supports the driven member (40) at a location corresponding to a nearest point where the driven member (40) is displaced nearest from the rotary shaft (11). The first supporting surface (21) of the previous embodiment may be omitted from the driving surface (20) of the driving member (30).

Specifically, the driven member 40 is disposed at the farthest location when the driven surface 41, which is in surface contact with the driving surface 20, is supported by the second support surface 23, which will be explained later. The driven member 40 is disposed at the nearest location when the driven surface 41 has followed the sloped surfaces 22, 24 by the rotation of the driving member 30 and a part of the driven member 40 is supported by the second supporting surface 23. Through this mechanism, the driven member 40 is capable of linearly moving between the farthest and nearest points through the rotation of the driving member 30.

The driven member 40 can have various configurations so long as it is capable of linearly moving along the rotary shaft 11 without rotating around the rotation axis 11.

The driven member 40 is equipped with a driven surface 51 which is in surface contact with the driving surface 20 so as to linearly move through the rotation of the driving member 30.

The driven member 40 is supported and in surface contact with the driving surface 20 of the driving member 30. Accordingly, when the driving member 30 rotates, the driven member 40 can move linearly along the rotary shaft 11 depending on the shape of the driving surface 20, i.e., following the first supporting surface 21, the first sloped surface 22, the second supporting surface 23 and the second sloped surface 24 sequentially.

On the other hand, in case the rotary driver 10 rotates in a restricted range of degrees, the driven surface 51 will move linearly only on the first supporting surface 21, the first sloped surface 22, and the second supporting surface 23 sequentially.

Also, the driven surface 41 may have any shapes so long as it can be supported by the driving surface 20. It is preferable that the driven surface 41 be in point or line contact with the driving surface 20 with the minimum contact area to facilitate smooth movement along the driving surface 20.

In case the driven surface 41 of the driven member 40 is in line contact with the driving surface 20, it is preferable that the line contact be made in a radial direction around the rotary shaft 11.

On the other hand, the remaining parts of the driven member 40 excluding the driven surface 41 are tailored so that, when the driven surface 41 is supported by the first supporting surface 21, they are in contact or not in contact with the second supporting surface so as not to disturb the linear movement of the driven member 40 along the rotary shaft 11.

As an example, as illustrated in the drawings, the driven member 40 may have a driven surface which matches in shape with the driving surface 20.

Also, the driven member 40 may have various shapes and structures depending on the material of the driving member 30 and the shape of the driving surface 20.

The driven member 40, which is supported by the driving surface 20 when the driving member 40 rotates, should not be rotated to facilitate a linear movement. In order to achieve a linear movement, the driven member 40 is equipped with a guide 50 which guides the linear movement of the driven member 40 while preventing its rotation around the rotary shaft 11.

The guide 50 can have various shapes and configurations which allow guidance of the linear movement of the driven member 40 while preventing its rotation around the rotary shaft 11.

For example, while not limited thereto, the guide 50 may include at least one guide groove 51 formed along the direction of linear movement of the driven member 41, as illustrated in FIGS. 2A to 3B and FIG. 5A. In such case, the driven member 40 may be equipped with a protrusion 40 formed on its wall so as to facilitate linear movement of the driven member 40 along the guide groove 51.

An opposite configuration to the one depicted in FIGS. 2A to 3B and FIG. 5A may also be possible. In other words, the driven member 40 may alternatively be equipped with a groove and the guide 50 may be equipped with a protrusion adapted to be inserted into the groove formed on the driven member 40.

Various configurations of the driven member 40 may be possible for guiding the linear movement of the driven member 40 while preventing rotation of the driven member 40 around the rotary shaft 11.

One example of such configuration may be the protrusion and the groove in which the protrusion is inserted, as illustrated in FIGS. 2A to 3B and FIG. 5A.

Another example of preventing rotation and guidance of linear movement of the driven member 40 is as follows: at least a part of the driven member 40 has a cylindrical shape, and a part of the cylindrical shape is incised to form at least one incision 48 having a plane at one side. Further, the guide 50 is equipped with a guide surface 58 which is in surface contact with the at least one incision 48 formed on the driven member 48.

The guide 50 may have various other structures such as a housing structure, frame structure surrounding a side of the driven member 40.

When the driven member 40 is supported by the second supporting surface 23 following the first supporting surface 21, the driven member 40 is in a position illustrated in FIG. 2B, i.e., the driven member 40 is way from the rotary driver 10. Subsequently, when the driven member 40 is supported by the first supporting surface 21 through additional rotation of the driving member 30 by way of the rotary driver 10, the driven member 40 has returned to the state where the driven surface 21 of the driven member 40 is adhered to the driving surface 20, i.e., the state illustrated in FIG. 2A.

For this, an adhesion means may be additionally provided to maintain the driven surface 41 of the driven member 40 to its adhered state to the driving surface 20.

The adhesion means is provided to maintain the driven surface 41 of the driven member 40 to its adhered state to the driving surface 20. The adhesion means may maintain the driven surface 41 of the driven member 40 to its adhered state through magnetic force or elastic force.

As a specific example, the adhesion means may include a magnet 61 installed on at least one of the driven member 40 and the driving member 30.

More specifically, a magnet 61 may be installed on at least one of the driven member 40 and the driving member 30, and an adhesion member 62 to attract the magnet 61, i.e., a material which reacts with the magnetic force, such as a metallic material or magnet, can be installed at the other one.

In such case, the driven member 40 and the driving member 30 are preferably of materials which do not interact with the magnetic force, such as non-metallic materials or metals having non-magnetic characteristics.

In the embodiment illustrated in FIGS. 1 to 2C, the magnet 61 is of cylindrical shape, and is installed in the driven member 40 whereas the adhesion member 62 is installed at the driving member 30. In such case, the driven member 40 is provided with a hole in which the adhesion member 62 may be inserted in the direction of the rotary shaft 11 so that the adhesion member 62 does not interfere with a linear movement of the driven member 40.

The hole may be formed in a longitudinal direction of the rotary shaft 11, and the magnet 61 may be embedded in the hole. The top portion of the adhesion member 62 may be inserted into the hole when the driven member 40 moves linearly.

The magnet 61 and the adhesion member 62 keep the driven surface 41 of the driven member 40 adhered to the driving surface 20 through the magnetic attraction.

Any configuration may be possible for the adhesion means using the magnetic force so long as the configuration keeps the driven surface 41 of the driven member 40 adhered to the driving surface 20.

Another embodiment of the adhesion means includes an elastic member (not shown) which applies an elastic force to the driven member 40 against the driving member 30.

Any configuration may be possible for the adhesion member so long as the adhesion member is capable of applying an elastic force to the driven member 40 against the driving member 30.

In some applications, the adhesion means may be omitted depending on the usage of the actuator because a driving force to the driven member 40 is applied towards the driving member 30.

As described above, the actuator having the aforementioned structure converts the rotational movement of the driving member 30 into the linear movement of the driven member 40. The actuator having the aforementioned structure is applicable to various devices and systems, such as a linear motion generator of a door lock, a linear motion generator of an opening/closing member of an opening/closing valve, etc.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An actuator, comprising:
a rotary driver having a rotary shaft;
a driving member coupled to the rotary shaft of the rotary driver and having a driving surface;
a driven member, supported by the driving surface of the driving member, configured to linearly move along the rotary shaft by a rotation of the driving member without rotating around the rotary shaft.

2. The actuator of claim 1, wherein the driving surface comprises a first supporting surface, a first sloped surface, a second support surface, and a second sloped surface continuously in sequence along a circumferential direction around the rotary shaft, and
wherein the first supporting surface and the second supporting surface has a gap in height in a longitudinal direction of the rotary shaft.

3. The actuator of claim 1, wherein the driven member comprises a driven surface which is in surface contact with the driving surface so as to linearly move through a rotation of the driving member.

4. The actuator of claim 1, wherein the driven member comprises a driven surface which matches in shape to the driving surface.

5. The actuator of claim 1, further comprising:
a first rotation restrictor which is connected to at least one of the rotary shaft and the driving member, and at least one second rotation restrictor which allows the first rotation restrictor to rotate within a predetermined angle of degrees.

6. The actuator of claim 1, wherein the driving surface comprises at least one second supporting surface which supports the driven member at a location corresponding to a farthest point where the driven member is displaced farthest from the rotary shaft, and at least one sloped surface, connected to the at least one second supporting surface, which supports the driven member at a location corresponding to a nearest point where the driven member is displaced nearest from the rotary shaft.

7. The actuator of claim 1, further comprising a guide which guides the driven member to move linearly while preventing the driven member from rotating around the rotary shaft.

8. The actuator of claim 7, wherein one of the guide and the driven member is equipped with at least one guide groove formed along the linear movement of the driven member, and
wherein the other of the guide and the driven member is equipped with a protrusion which corresponds to the guide groove so that the protrusion moves linearly along the guide groove.

9. The actuator of claim 7, further comprising:
an adhesion mechanism which keeps the driven surface of the driven member adhered to the driving surface.

10. The actuator of claim 9, wherein the adhesion mechanism keeps the driven surface of the driven member adhered to the driving surface through a magnetic force or an elastic force.

11. The actuator of claim 9, wherein the adhesion mechanism comprises a magnet installed in at least one of the driven member and the driving member.

12. The actuator of claim 9, wherein the adhesion mechanism comprises an elastic member which applies an elastic force to the driven member against the driving member.
